(19) United States
(12) Patent Application Publication
(10) Pub. No.: US 2008/0097992 A1
(43) Pub. Date: Apr. 24, 2008

(54) Fast database matching

(76) Inventor: Donald Martin Monro, Beckington (GB)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/585,365

(22) Filed: Oct. 23, 2006

(51) Int. Cl. G06F 17/30

(52) U.S. Cl. 707/6

(57) ABSTRACT

A method of improving the speed with which a sample can be matched against records in a database comprises defining a list (24) of possible characteristics (26), extracting characteristics from the sample and, for each record in the database, counting the number of characteristics that match both the record and the sample. A list of candidate matches is then selected on the basis of that count, for more detailed matching or analysis. Such a method provides very fast matching at the expense of some additional effort when registering a new record within the database.

### CROSS-REFERENCE TO RELATED APPLICATIONS

This application is being filed concurrently with U.S. application Ser. No. ______ (not yet assigned) entitled “Fuzzy Database Matching” (Attorney Docket No. 52076-7005), the contents of which are hereby incorporated by reference.

### FEDERALLY SPONSORED RESEARCH OR DEVELOPMENT

None.

### TECHNICAL FIELD

The invention relates to the field of database systems. In particular, it relates to a method and system for improving the speed with which a candidate record may reliably be matched against a record within the database.

### BACKGROUND OF THE INVENTION

There is increasing need within a variety of fields to be able to determine very rapidly whether or not a particular sample record already exists within a large database, and if so to identify one or more matches. One particular field is biometrics, in which the requirement is to determine whether or not the individual who has provided a particular biometric sample is already in the database. A further exemplary field is that of digital rights management, where the need is to check whether a particular piece of music, video, image or text matches a corresponding record within a database of copyright works.

Databases of the type described can be extremely large, and it may be impractical to attempt a full match analysis between the sample record and every one of the records within the database. In order to reduce the computational workload, a variety of pre-screening processes are in use, but many of these have very restricted fields of application since they often rely upon specific peculiarities of the matching algorithm or of the data that are to be matched.

The present invention is provided to solve the problems discussed above and other problems, and to provide advantages and aspects not provided by prior database systems of this type. A full discussion of the features and advantages of the present invention is deferred to the following detailed description, which proceeds with reference to the accompanying drawings.

### SUMMARY OF THE INVENTION

According to the present invention there is provided a method of identifying possible matches between a sample record and a plurality of stored records, the method comprising:
(a) Explicitly or implicitly defining a list of characteristics, and associating with each characteristic those stored records which display said characteristic;
(b) Extracting characteristics from the sample record; and
(c) Identifying a given stored record as being a possible match with the sample if it is associated with a required number of extracted characteristics.

The required number may be determined according to any convenient algorithm, such as a threshold dependent upon the application. The threshold may conveniently be a simple numerical count, or could alternatively be some more complex metric depending not only upon the number of matching characteristics, but also upon the number of times that those characteristics match the sample record and/or match the corresponding stored record.

The extraction may be carried out by applying a desired function/operation to the sample record, or to part of it (the same function/operation used to extract the registered characteristics from the stored records). The extraction may in one embodiment be carried out by a search through the data for a variety of sub-features, although non-search extraction will in many applications be preferred.

The list of characteristics may be hand-crafted (user generated) or alternatively could be generated automatically from the stored records. The list of characteristics could be selective (for example some of the words to be found within the text of a book), or could be comprehensive (all occurring words are automatically added to the list). The characteristics may all be of the same type or class, but that is not essential and it is contemplated that a single list may contain features of a variety of types (for example individual words, phrases, font size and font information, layout information and so on).

Once a list of possible candidate matches between the sample record and the stored records has been generated, further analysis may be carried out on those retrieved records. Typically, although not necessarily, the sample record and the list of possible matching records may then be passed to a more sophisticated matching algorithm to determine which of the candidate matches are true matches.

Such a method provides very fast candidate-matching at the expense of some additional effort when registering a new record within the database. The trade-off is well worth while when matching is done frequently in comparison with the frequency of registration of new records.

According to a further aspect of the present invention, there is provided a system for identifying possible matches between a sample record and a plurality of stored records, the system comprising:
(a) A list of characteristics, each characteristic having associated with it those stored records which display said characteristic;
(b) A processor for extracting characteristics from the sample record; and
(c) A processor for identifying a given stored record as being a possible match with the sample if it is associated with a required number of extracted characteristics.

In some embodiments, separate processors may be used for matching characteristics against sample records, and for identifying stored records as possible matches. These processors may be on separate computers, and may be remote from each other.

In one particular embodiment, the main data list including the full collection of stored records may be held separately from the characteristic list. That allows a local processor, for example a processor embedded within a photocopying machine, to carry out the initial analysis on a sample record such as a photocopied page of text. Once a list of possible matches has been identified, that list can then be passed to a remote server, where a more detailed analysis can be carried out by comparing the sample with the full text of each of the possible matches.

This approach has the further advantage that the designer of the system does not need to distribute to a large number of users full copies of the entire corpus of copyright works. Instead, each user simply receives an explicit or implicit list of characteristics, which is enough for the initial analysis to be carried locally. Where one or more possible matches are found, the system may then be automatically report to a central location where further analysis can be carried out against the full documents.

Other features and advantages of the invention will be apparent from the following specification taken in conjunction with the following drawings.

### BRIEF DESCRIPTION OF THE DRAWINGS

The invention may be carried in practice in a number of ways and some specific embodiments will now be described, by way of example, with reference to the accompanying drawings, in which:

FIG. 1 shows the database structure according to an embodiment of the invention;

FIG. 2 is a histogram exemplifying the matching process;

FIG. 3 is another exemplary histogram; and

FIG. 4 shows some exemplary hardware.

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description which follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

For the sake of clarity, the description below will be directed toward an exemplary embodiment in the digital rights management field. In the embodiment to be described, a database contains details of a large number of published books which are currently in copyright. A website has been found onto which has been posted lengthy extracts from a variety of books. The task is to determine which, if any, of those extracts have been taken from books which are recorded within the database. It will of course be understood that this particular example is simply used to illustrate the general principles behind the invention, and that the same techniques will be equally applicable in other fields. The invention in its broadest form is not restricted to any particular class or type of data held within the database, nor to the details of the matching algorithms that are used.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

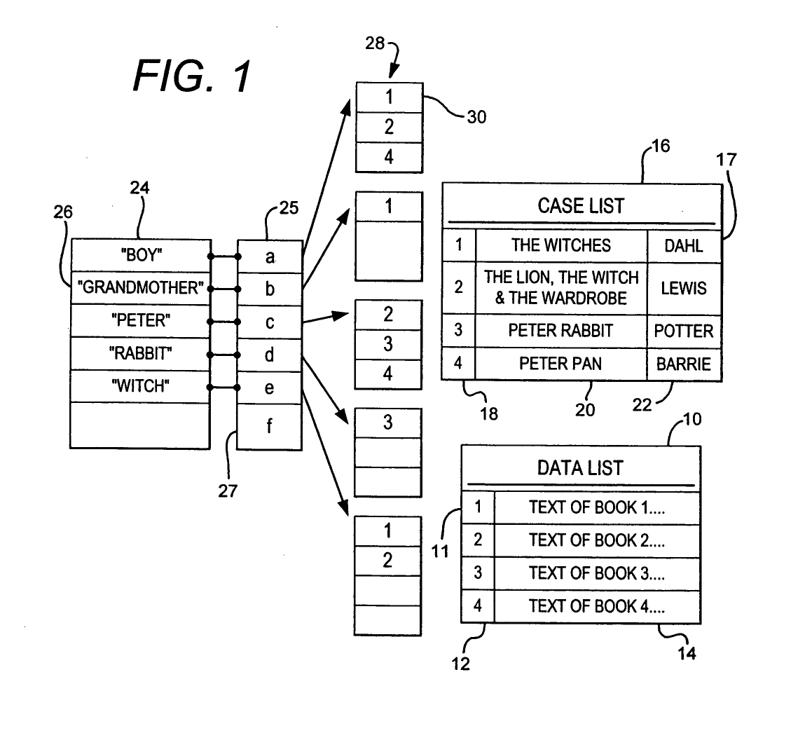

The database structure of an exemplary embodiment is shown schematically in FIG. 1. Bibliographic details of the individual books within the database are held within a case list or table 16, each row 17 of which represents an individual book. Columns 18, 20, 22 respectively hold a unique reference number, the book title, and the author. Of course, in a practical embodiment, many more details about each individual book would probably be held.

The full text of each book is held within a data list or table 10, each row 11 of which represents an individual book. This table consists of two columns, the first 12 being the unique reference number, mentioned above, and the second 14 holding the complete text of the book in some suitable encoded form. More generally, the column 14 may be considered to hold some generalized representation which uniquely identifies the individual record.

To assist in searching the database, a characteristic list or table 24 is created. Each row 26 holds a variety of different characteristics which may be found within the records of column 14 within the data list 10. These characteristics are selected so as to be reasonably common (but not overwhelmingly so), in at least some of the books. The characteristics may be any easily-measurable attribute of the data, and the type of characteristic chosen will clearly depend upon the application. In some embodiments, as here, the characteristic may be a sub-feature; in others it may be extracted from the data or some part of it by the application of an operation/function such as a hash function.

In the embodiment being described the characteristics are individual words, namely “boy,” “grandmother,” “Peter,” “rabbit” and “witch.” Each row in the characteristic table points to a corresponding row 27 within a look-up table 25 which holds a series of pointers which have, here, been designated a, b, c and so on. Each pointer points to a specific memory location which defines the start of an individual case occurrence list 28 which corresponds to the particular linked characteristic within the table 24. There will accordingly, be multiple case occurrence lists, one for each characteristic within the table 24. The individual case occurrence lists 28 are populated with the unique reference number of every book in which that particular characteristic can be found. Conveniently, each row 30 in each list or table simply contains the reference of a single book which includes, displays or demonstrates the relevant characteristic, or from which the characteristic can be extracted. Thus, in the example shown, the first case occurrence list contains the data 1, 2 and 4, which implies that the characteristic “boy” appears in or can be extracted from the books “The Witches,” “The Lion, The Witch and the Wardrobe” and “Peter Pan”. The second list which relates to the characteristic “grandmother” consists of a single row which is populated with the reference number 1, indicating that the word “grandmother” occurs in the book “The Witches” only.

In another arrangement (not shown) the characteristic table 24 and the lookup table 25 may be merged into a single table having two columns.

The way in which the system is maintained and is used for searching will now be described.

To add a new characteristic (in this example, a new word) the characteristic is added to the list 24 of registered characteristics, in the appropriate position if that list is ordered. A block of memory is allocated for a new case occurrence list, and the relevant pointer added to the look-up table 25. Finally, the new case occurrence list is populated with the reference numbers of those cases, (e.g., books) from which the newly-added characteristic can be extracted.

When a new case (book) is to be registered, the case list 16 and the data list 10 are updated accordingly, and the new case number is then added to the respective case occurrence list for each extracted characteristic. In some embodiments, the list of characteristics 24 may consist all of those characteristics which are contained within or which can be extracted or derived from the entire corpus of data within the data list 10; then, the addition of a new case may automatically trigger the registration of any new characteristics, extracted from the new case, which are not already included within the list 24.

We now turn to the task of matching, or in other words determining whether an unknown data set or sample of text has been taken from one of the books within the database. Rather than matching the sample against the data 14 (the full text of each book), which would be computationally lengthy, characteristics are simply extracted from the sample for comparison with the already-registered characteristics. By referring to the individual case occurrence lists 28, a count may be kept of the number of times a reference to a particular book occurs within a matched table.

In a simplistic embodiment, the matching might be carried out by way of a straightforward row-by-row search through the rows 26 of the characteristic list, but it will often be preferable to avoid this by ensuring that the characteristic list is ordered, and then using some more sophisticated search such as a binary search. Such an approach allows a matching characteristic to be found rapidly, and for a non-match to be identified rapidly in the event that the extracted sample characteristic is not registered within the list.

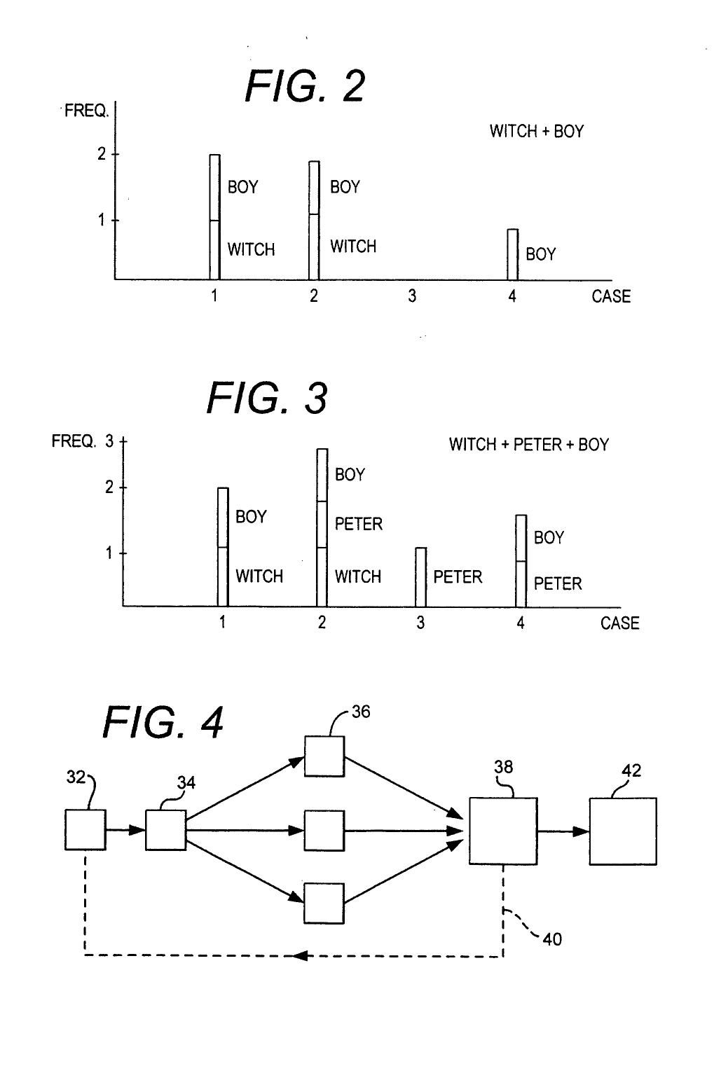

FIG. 2 illustrates an example in which the sample text has matched against the characteristics “witch” and “boy”. The count is shown schematically as histogram, although such a histogram would not necessarily be plotted in a working embodiment. As may be seen, there are two books in the database that have matched characteristics, namely “The Witches” and “The Lion, the Witch and the Wardrobe”. “Peter Rabbit” has no matches, and “Peter Pan” one.

Next, a threshold is applied to the count, and any book which scores at least the threshold value is considered to be a candidate match. Here, if the threshold is taken as one, all of the books except Peter Rabbit are candidate matches, and if the threshold is taken as two then the candidates are The Witches and The Lion, the Witch and the Wardrobe.

A further example is given in FIG. 3, which represents another text sample in which matches have been found against the characteristics “witch,” “Peter” and “boy”. If a threshold of two is chosen, all of the books within the database match except for Peter Rabbit.

The value of the threshold may be selected by the user by trial and error, according to the particular application and the extent to which the pre-selection process needs to remove a large number of cases from consideration in order to speed up the overall matching process. Although the use of a simple count and a fixed threshold is a convenient way of dividing possible matches from non-matches, other algorithms could equally well be used. One possible approach, for example, would be to select as a candidate match all of those cases having a characteristic count which is more than a fixed percentage higher than the average characteristic count taken across all cases.

Depending upon the size of the sample to be evaluated, it may not be necessary to use the sample in its entirety. For example, if the sample consists of several chapters of a book, it may be enough to carry out the pre-selection based on just one page of text.

The selection of characteristics, the matching criteria and the size of sample to be analyzed will in most applications be chosen so that there is an acceptably low risk of a false rejection.

As described above, a characteristic might be a data fragment such as a word or phrase, or could alternatively represent some other attribute of the data. The characteristic might, for example, be extracted or derived from the data by applying to it or to some part thereof an operation such as a hash function. The output of the operation may then be used to access and/or search the characteristic table 24. Where the number of possible characteristics is finite and is known in advance, it may be desirable in some applications for all possible characteristics within a defined characteristic space to be pre-registered. Such an arrangement obviates the need, on matching, to search the characteristic list 24. Instead the sample record is simply processed to extract its characteristics, and the corresponding rows in the table 24 are used as indexes to the case occurrence lists applicable to those particular characteristics.

For example in a biometric application, the characteristic might be a numeric code of a particular length (e.g. 16 bits, allowing 65536 possible characteristic values to occur). In a database there might be millions or billions of records, so that each possible characteristic may occur many times. To match a sample, one simply extracts one or more characteristics from it, for example by hashing, and uses the characteristic to address the characteristic table and thus go to straight to the relevant lists 28 of stored records.

In some applications it may even be possible to dispense with the characteristic list 24 entirely. If the list is ordered and contains all possible characteristic values within a defined characteristic space (for example the numbers 1 to 65536), maintaining the list as a separate entity is unnecessary since all of its values can be inferred. In such a case, a characteristic n which has been extracted from a sample can be used as an index to go straight to row n of the look-up table 25, and thus directly to the corresponding case occurrence list 28.

More generally, where the list of possible characteristics is finite and can be defined in advance, those characteristics can be mapped onto a numerical sequence 1 . . . N. Let us assume that applying the same mapping to a characteristic which has been extracted from an unknown sample gives a value of n<=N. If the look-up table 25 is held as a vector L(N), then the location in memory of the relevant case occurrence list 28 for that particular characteristic may be found by looking at the pointer which is held at the position L(n).

It will of course be understood that the case occurrence lists 28 may in some embodiments be empty.

Once a list of candidate matches has been selected, using one of the procedures described above, a more detailed match may then be carried out against each of the possibilities, using any convenient matching algorithm. In the text example described, the sample text may be compared word for word against the full text of each of the possible matches.

In one embodiment, the database itself may be held on the same computer or at the same location where the preliminary and/or the final matching takes place. Alternatively, the process may be distributed, with the preliminary matching being carried out according to a characteristic list held at a local computer, and the preliminary matches being passed on to a remote computer for the detailed matching to take place. Such an arrangement allows the primary data list 10 (which includes the full data representing all the cases) to be held at a central location, with a local machine needing to hold just the characteristic list 24 and the individual lists 28.

In another embodiment, shown in FIG. 4, the process of the present invention may further be speeded up by using multiple computers or processors operating in parallel. A user computer 32 forwards a matching task to a controller 34 which splits it up and distributes it between a plurality of computers or processors 36. Each processor 36 may be instructed to handle a particular characteristic or group of characteristics, and is responsible for creating a subset of the case occurrence lists; alternatively, the controller 34 may split up the work in some other way. The processors 36 pass their lists onto a consolidator 38, which finalizes the selection of candidate matches (for example using the histogram/count procedures illustrated in FIGS. 2 and 3). The list of possibilities is then forwarded as required, either to a computer or processor 42 which carries out more detailed matching, or as shown by reference numeral 40 back to the user 32 for further analysis.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

While the specific embodiments have been illustrated and described, numerous modifications come to mind without significantly departing from the spirit of the invention, and the scope of protection is only limited by the scope of the accompanying Claims.

What is claimed is:

1. A method of identifying possible matches between a sample record and a plurality of stored records, the method comprising:
defining a list of characteristics, and associating with each characteristic those stored records which display said characteristic;
extracting characteristics from the sample record; and
identifying a given stored record as being a possible match with the sample if it is associated with a required number of extracted characteristics.

2. A method as claimed in claim 1 in which the required number is a numerical threshold.

3. A method as claimed in claim 1 in which the required number is a function of the average number of matching characteristics per stored record.

4. A method as claimed in claim 1 in which the list of characteristics is user-generated.

5. A method as claimed in claim 1 in which the list of characteristics is automatically generated from the stored records.

6. A method as claimed in claim 1 in which the list of characteristics defines all characteristics within a characteristic space that are displayed by the said plurality of stored records.

7. A method as claimed in claim 1 in which the list of characteristics defines all possible characteristics within a characteristic space that could be displayed by a sample record.

8. A method as claimed in claim 8 in which the list of characteristics is implicit and is not stored as a separate entity.

9. A method as claimed in claim 1 in which the list of characteristics is stored within a database table.

10. A method as claimed in claim 1 in which the list of characteristics is ordered.

11. A method as claimed in claim 1 in which each characteristic is a stored-record fragment.

12. A method as claimed in claim 1 in which the list of characteristics is generated by applying an operation, such as a hash, to the stored records.

13. A method as claimed in claim 1 in which said associating step comprises maintaining a pointer linking each said characteristic to a case occurrence list which contains those stored records which display said characteristic.

14. A method as claimed in claim 13 in which the said pointers are held in a lookup table.

15. A method as claimed in claim 1 in which the extracting step comprises searching the sample record for characteristics which appear in the characteristic list.

16. A method as claimed in claim 1 in which the extracting step comprises applying an operation to the sample record to generate one or more extracted characteristics.

17. A method as claimed in claim 1 in which the extracting step comprises applying an operation to the sample record to generate one or more sample outputs, and searching said sample outputs against said characteristic list.

18. A method as claimed in claim 1 in which the list of characteristics defines all possible characteristics within a characteristic space that could be displayed by a sample record; and in which said matching step comprises applying an operation to the sample record to generate one or more sample outputs, and using the sample outputs to address a lookup table, each row in said lookup table pointing to a case occurrence list which records occurrences of each stored record that displays a corresponding characteristic.

19. A method as claimed in claim 1 in which as characteristics are extracted a histogram is built up recording matches by stored record; and identifying records as possible matches from the histogram.

20. A method as claimed in claim 1 including the additional step of further analyzing the relationship between the sample record and each of the said possible matches.

21. A method as claimed in claim 1 in which the said extracting step is divided between a plurality of parallel processors, each forwarding a association result to a consolidator, said consolidator identifying stored records as possible matches in dependence upon said association results.

22. A system for identifying possible matches between a sample record and a plurality of stored records, the system comprising:
a list of characteristics, each characteristic having associated with it those stored records which display said characteristic;
a processor for extracting characteristics from the sample record; and
a processor for identifying a given stored record as being a possible match with the sample if it is associated with a required number of extracted characteristics.

23. A system as claimed in claim 22 in which the processor for extracting and the processor for identifying consist of a common processor.

24. A system as claimed in claim 22 in which the processor for extracting is remote from the processor for identifying.

25. A system as claimed in claim 22 in which the processor for extracting comprises a plurality of parallel processors, each forwarding an association result to a consolidator, said consolidator identifying stored records as possible matches in dependence upon said association results.
